(19) United States
(12) Patent Application Publication
(10) Pub. No.: US 2020/0334010 A1
(43) Pub. Date: Oct. 22, 2020

(54) METHOD AND APPARATUS FOR DATA ALIGNMENT AND COMPUTING DEVICE FOR EXECUTING DATA ALIGNMENT

(71) Applicant: RESEARCH COOPERATION FOUNDATION OF YEUNGNAM UNIVERSITY, Gyeongsangbuk-do (KR)

(72) Inventor: Gyu Sang CHOI, Daegu-si (KR)

(21) Appl. No.: 16/851,350

(22) Filed: Apr. 17, 2020

(30) Foreign Application Priority Data
Apr. 17, 2019 (KR) 10-2019-0044806

(51) Int. Cl. G06F 7/08

(52) U.S. Cl. CPC G06F 7/08

(57) ABSTRACT

A method of data alignment according to an embodiment of the present invention is performed by a computing device including one or more processors and a memory in which one or more programs to be executed by the one or more processors are stored, and the method includes counting the number of target data to be aligned, calculating a distribution of the target data, determining the number of bits of a bucket and the number of slots of the bucket for aligning the target data on the basis of the number of target data and the distribution of the target data, and generating buckets corresponding to the determined numbers of bits and slots and allocating the target data to the buckets to align the target data.

### CROSS-REFERENCE TO RELATED APPLICATION (S)

This application claims the benefit under 35 USC § 119(a) of Korean Patent Application No. 10-2019-0044806, filed on Apr. 17, 2019, in the Korean Intellectual Property Office, the entire disclosure of which is incorporated herein by reference for all purposes.

### BACKGROUND

### 1. Field

The following description relates to data alignment technology.

### 2. Description of Related Art

One of the most important issues in the computer field is to arrange pieces of given data in a particular order. In the case of data used in an actual computer field, it is almost always necessary to sort the data in the order of numbers or vocabularies, and how efficiently the data can be sorted is a key to the alignment issue.

Data alignment is required for data search. If target data to be searched is not aligned, no other algorithms than sequential search can be used, but if the target data is aligned, it is possible to use a powerful algorithm, so called, binary search.

The characteristic of already-aligned data is that, when a value is randomly selected, a value greater than or equal to the selected value is located to the right of the value and a value smaller than or equal to the selected value is located to the left of the value. Therefore, if a computer selects a value and the selected value is smaller than a value to be searched, there is no need to search the data located to the left of the value of interest. The main reason for performing data alignment on a computer is to make data binary searchable.

There are various data alignment techniques. Among them, in a bucket sort technique, when there are pieces of data to be sorted, each data is put in a corresponding bucket after generating buckets each representing specific data, and only the pieces of data in the corresponding bucket are sorted later. However, the existing bucket sort technique has a problem in that the number of buckets is fixed and hence the performance is deteriorated when the pieces of data to be sorted are biased.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a method and apparatus for data alignment, which can improve data alignment performance, and a computing device for performing the data alignment.

In one general aspect, there is provided a method of data alignment which is performed by a computing device including one or more processors and a memory in which one or more programs to be executed by the one or more processors are stored, the method including counting the number of target data to be aligned, calculating a distribution of the target data, determining the number of bits of a bucket and the number of slots of the bucket for aligning the target data on the basis of the number of target data and the distribution of the target data, and generating buckets corresponding to the determined numbers of bits and slots and allocating the target data to the buckets to align the target data.

The determining may include checking whether the number of target data is greater than or equal to a preset reference number, checking whether the distribution of the target data is greater than or equal to a preset reference distribution when the number of target data is greater than or equal to the preset reference number, and determining the number of bits of a bucket and the number of slots of a bucket according to a preset first rule when the distribution of the target data is greater than or equal to the preset reference distribution.

The determining of the number of bits of the bucket and the number of slots of the bucket according to the first rule may include setting the number of bits of a bucket of a first level to be greater than the preset reference number of bits and setting the number of slots of the bucket of the first level to be smaller than the preset reference number of slots.

The determining of the number of bits of the bucket and the number of slots of the bucket according to the first rule may include, in a case of a bucket of a lower level than the first level, setting the number of bits of the bucket of the lower level to be less than the preset reference number of bits and setting the number of slots of the bucket of the lower level to be greater than the preset reference number of slots.

The method may further include, when the distribution of the target data is less than the preset reference distribution, determining the number of bits of a bucket and the number of slots of a bucket according to a preset second rule, wherein the determining of the number of bits of the bucket and the number of slots of the bucket according to the second rule may include setting the number of bits of a bucket of a first level to be greater than the preset reference number of bits and setting the number of slots of the bucket of the first level to be greater than the preset reference number of slots.

The determining of the number of bits of the bucket and the number of slots of the bucket according to the second rule may include, in a case of a bucket of a lower level than the first level, setting the number of bits of the bucket of the lower level to be less than the preset reference number of bits and setting the number of slots of the bucket of the lower level to be less than the preset reference number of slots.

The determining may include checking whether the number of target data is greater than or equal to a preset reference number, checking whether the distribution of the target data is greater than or equal to a preset reference distribution when the number of target data is less than the preset reference number, and determining the number of bits of a bucket and the number of slots of a bucket according to a preset third rule when the distribution of the target data is greater than or equal to the preset reference distribution.

The determining of the number of bits of the bucket and the number of slots of the bucket according to the third rule may include setting the number of bits of a bucket of a first level to be less than the preset reference number of bits and setting the number of slots of the bucket of the first level to be greater than the preset reference number of slots.

The determining of the number of bits of the bucket and the number of slots of the bucket according to the third rule may include, in a case of a bucket of a lower level than the first level, setting the number of bits of the bucket of the lower level to be greater than the preset reference number of bits and setting the number of slots of the bucket of the lower level to be less than the preset reference number of slots.

The method may further include, when the distribution of the target data is less than the preset reference distribution, determining the number of bits of a bucket and the number of slots of a bucket according to a preset second rule, wherein the determining of the number of bits of the bucket and the number of slots of the bucket according to the fourth rule may include setting the number of bits of a bucket of a first level to be less than the preset reference number of bits and setting the number of slots of the bucket of the first level to be less than the preset reference number of slots.

The determining of the number of bits of the bucket and the number of slots of the bucket according to the fourth rule may include, in a case of a bucket of a lower level than the first level, setting the number of bits of the bucket of the lower level to be greater than the preset reference number of bits and setting the number of slots of the bucket of the lower level to be greater than the preset reference number of slots.

The generating of the buckets may include generating buckets of a first level corresponding to the determined numbers of bits and slots and allocating and storing data of a predetermined most significant bit among the target data to the bucket of the first level, and when a slot of a bucket corresponding to a predetermined bit value among the buckets of the first level is occupied, generating buckets of a second level for the corresponding bucket of the first level corresponding to the determined numbers of bits and slots.

In another general aspect, there is provided a computing device including one or more processors, a memory, and one or more programs, wherein the one or more programs are stored in the memory and configured to be executed by the one or more processors and the one or more programs include instructions for counting the number of target data to be aligned, calculating a distribution of the target data, determining the number of bits of a bucket and the number of slots of the bucket for aligning the target data on the basis of the number of target data and the distribution of the target data, and generating buckets corresponding to the determined numbers of bits and slots and allocating the target data to the buckets to align the target data.

In still another general aspect, there is provided an apparatus for data alignment including a determiner configured to count the number of target data to be aligned, calculate a distribution of the target data, and determine the number of bits of a bucket and the number of slots of the bucket for aligning the target data on the basis of the number of target data and the distribution of the target data and a bucket processor configured to generate buckets corresponding to the determined numbers of bits and slots and allocate the target data to the buckets to align the target data.

In yet another general aspect, there is provided a computer program, stored in a non-transitory computer-readable storage medium, including one or more instructions which, when executed on a computing device including one or more processors, cause the computing device to perform operations of: counting the number of target data to be aligned, calculating a distribution of the target data, determining the number of bits of a bucket and the number of slots of the bucket for aligning the target data on the basis of the number of target data and the distribution of the target data, and generating buckets corresponding to the determined numbers of bits and slots and allocating the target data to the buckets to align the target data.

Other features and aspects will be apparent from the following detailed description, the drawings, and the claims.

### BRIEF DESCRIPTION OF THE DRAWINGS

FIG. 1 is a block diagram for describing a computing environment including a computing device suitable for use in exemplary embodiments.

FIGS. 2 to 5 are diagrams for describing a method of data alignment according to one embodiment of the present invention

FIG. 6 is a flowchart illustrating a method for determining the number of bits in a bucket and the number of slots in a bucket according to one embodiment of the present invention.

FIG. 7 is a block diagram illustrating a configuration of an apparatus for data alignment according to one embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

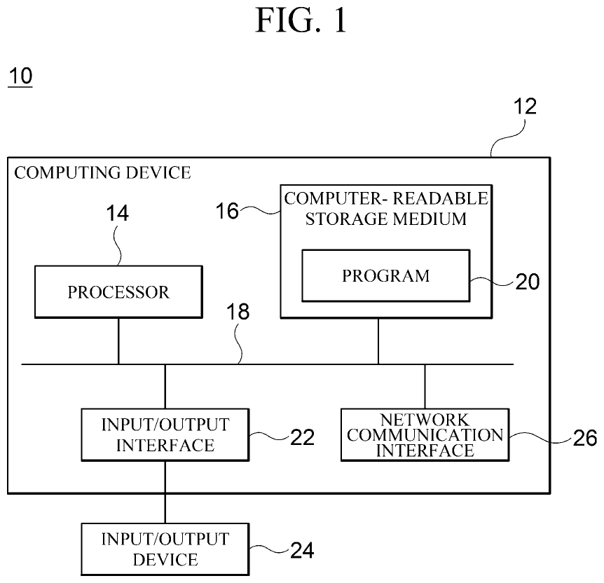

FIG. 1 is a block diagram for describing a computing environment 10 including a computing device suitable for use in exemplary embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be a device for performing image processing according to one embodiment of the present invention.

The computing device 12 may include at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable instructions, and the computer executable instructions may be configured to, when executed by the processor 14, cause the computing device 12 to perform operations according to the exemplary embodiment.

The computer readable storage medium 16 is configured to store computer executable instructions and program codes, program data and/or information in other suitable forms. The programs stored in the computer readable storage medium 16 may include a set of instructions executable by the processor 14. In one embodiment, the computer readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

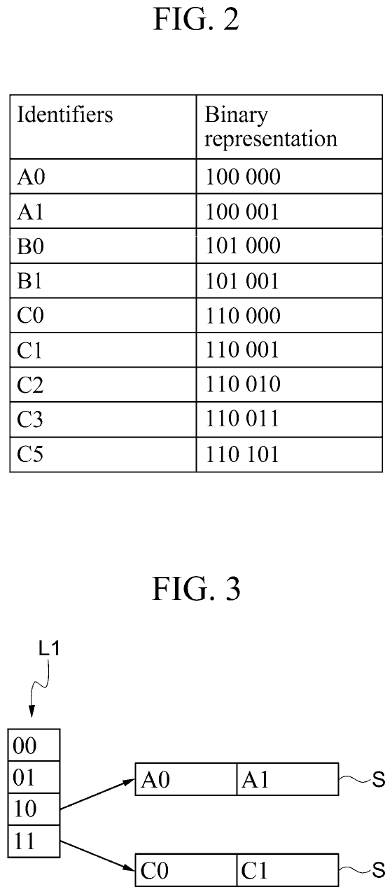

FIGS. 2 to 5 are diagrams for describing a method of data alignment according to one embodiment of the present invention. As described above, the method of data alignment may be performed in the computing device 12 including one or more processors and a memory in which one or more programs to be executed by the one or more processors are stored. To this end, the method of data alignment may be configured in the form of a program or software including one or more computer-executable instructions and be stored in the memory.

FIG. 2 is a table showing target data to be aligned according to a method of data alignment according to one embodiment of the present invention. Herein, for convenience of description, target data will be described as being represented by 6 bits.

FIG. 3 is a diagram illustrating an initial data alignment state when A0, A1, C0, and C1 exist in target data. Here, a 6-bit representation of A0 is 100000, a 6-bit representation of A1 is 100001, a 6-bit representation of C0 is 10000, and a 6-bit representation of C1 is 110001.

Referring to FIG. 3, a first-level bucket L1 for aligning pieces of target data A0, A1, C0, and C1 based on a value of the highest 2 bits of the target data may be generated. The values of the most significant 2 bits of the target data are 00, 01, 10, and 11, and thus four first-level buckets L1 may be generated. Here, each first-level bucket L1 may be connected to two slots S so as to store two pieces of data. Each slot S may store one piece of data. In this case, A0 and A1 among the target data may each be stored in each slot of a bucket having a value of 10 among the first-level buckets L1. In addition, C0 and C1 among the target data may each be stored in each slot of a bucket having a value of 11 among the first-level buckets L1.

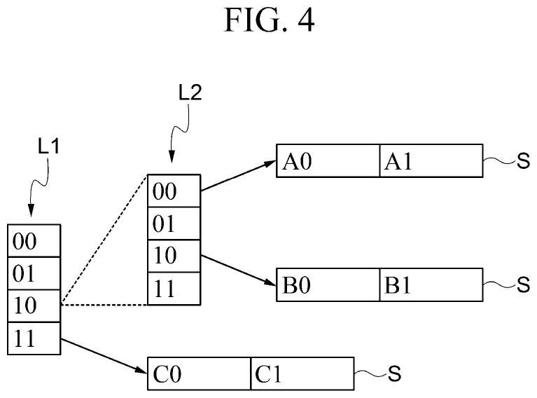

FIG. 4 is a diagram illustrating a data alignment state when B0 and B1 are added to the target data. Here, a 6-bit representation of B0 is 101000, and a 6-bit representation of B1 is 101001.

Referring to FIG. 4, a value of the most significant 2 bits of the added data B0 and B1 is 10. Since all slots S of the bucket having a value of 10 among the first-level buckets L1 are occupied, second-level buckets L2 for the corresponding first-level bucket may be generated.

The second-level buckets L2 may be buckets for aligning lower bits than the most significant 2 bits of the target data. For example, when the target data is 6 bits, the first-level buckets L1 may be used to align the data of the most significant 2 bits and the second-level buckets L2 may be used to align the data of the intermediate 2 bits. Four second-level buckets L2 may be generated to represent the intermediate 2 bits. Each second-level bucket L2 may be connected two slots so as to store two pieces of data.

Here, among the target data, A0 (6-bit value: 100000) and A1 (6-bit value: 100001) may be stored in a second-level bucket L2 of the bucket having a value of 10 among the first-level buckets L1 and may each be stored in each slot of the bucket having a value of 00 among the second-level buckets L2. Among the target data, B0 (6-bit value: 101000) and B1 (6-bit value: 101001) may be stored in a second-level bucket L2 of the bucket having a value of 10 among the first-level buckets L1 and may each be stored in each slot of the bucket having a value of 10 among the second-level buckets L2. Among the target data, C0 (6-bit value: 11000) and C1 (6-bit value: 110001) may each be stored in each slot S of the bucket having a value of 11 among the first-level buckets L1.

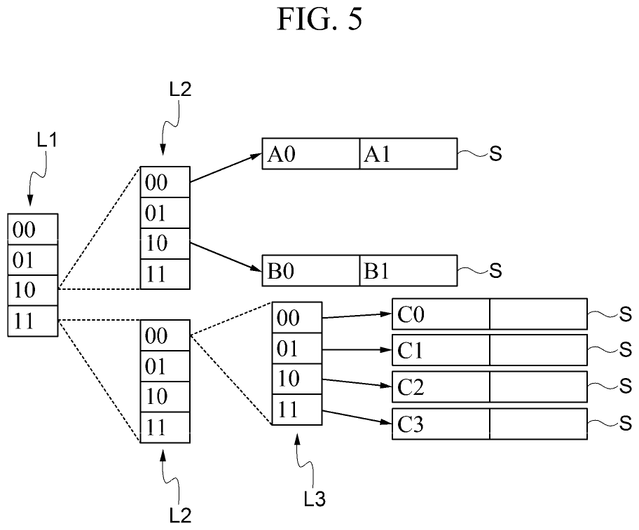

FIG. 5 is a diagram illustrating a data alignment state when C2 and C3 are added to the target data. Here, a 6-bit representation of C2 is 110010 and a 6-bit representation of C3 is 110011.

Referring to FIG. 5, since a value of the most significant 2 bits of each of the added data C2 and C3 is 11 and all slots S of the bucket having a value of 11 among the first-level buckets L1 are occupied, second-level buckets L2 may be generated for the corresponding first-level bucket.

On the other hand, a value of the intermediate 2 bits of each of the added data C2 and C3 is 00 and a value of the intermediate 2 bits of the existing data C0 and C1 is 00, and hence all slots of the second-level bucket L2 having a value of 00 are occupied. Therefore, third-level buckets L3 may be generated for the second-level bucket having a value of 00.

The third-level buckets L3 may be buckets for aligning the last 2 bits of the target data. That is, when the target data is 6 bits, the first-level bucket L1 may be used to align the data of the most significant 2 bits, the second-level bucket L2 may be used to align the data of the intermediate 2 bits, and the third-level bucket L3 may be used to align the data of the last 2 bits. Four third-level buckets L3 may be generated to represent the last 2 bits. Each third-level bucket L3 may be connected to two slots S so as to store two pieces of data.

Here, among the target data, C0 (6-bit value: 110000) may be stored in a third-level bucket L3 of the bucket having a value of 00 among the second-level buckets L2 of the first-level bucket L1 having a value of 11 and may be stored in a slot S of the bucket having a value of 00 among the third-level buckets. Among the target data, C1 (6-bit value: 110001) may be stored in a third-level bucket L3 of the bucket having a value of 00 among the second-level buckets L2 of the first-level bucket L1 having a value of 11 and may be stored in a slot S of the bucket having a value of 01 among the third-level buckets L3.

Among the target data, C2 (6-bit value: 110010) may be stored in a third-level bucket L3 of the bucket having a value of 00 among the second-level buckets of the first-level bucket L1 having a value of 11 and may be stored in a slot S of the bucket having a value of 10 among the third-level buckets L3. Among the target data, C3 (6-bit value: 110001) may be stored in a third-level bucket L3 of the bucket having a value of 00 among the second-level buckets of the first-level bucket L1 having a value of 11 and may be stored in a slot S of the bucket having a value of 11 among the third-level buckets L3.

In this case, by using a bitmap, it is possible to quickly find a slot to which the data is allocated and an empty slot in the bucket. For example, in the case of a bucket having eight slots, if a bitmap is not used, it is necessary to sequentially check whether each slot is empty from the first slot to a slot of interest. On the contrary, when a bitmap is used, it is only necessary to identify a value of 8 bits in order to find out which slot is empty in the eight slots, and thus the time required to find an empty slot may be reduced.

In the disclosed embodiment, buckets may be configured in various levels according to the number of data to be aligned. Here, the levels of the buckets may be provided in a stepwise manner such that the target data is aligned from higher-order bits to lower-order bits thereof. In addition, the number of levels of the buckets and the size of the buckets may vary according to the number of data. In an exemplary embodiment, the number of bits of a bucket of each level and the number of slots of each bucket may be determined according to the number of target data (i.e., data to be aligned) and the distribution of the target data.

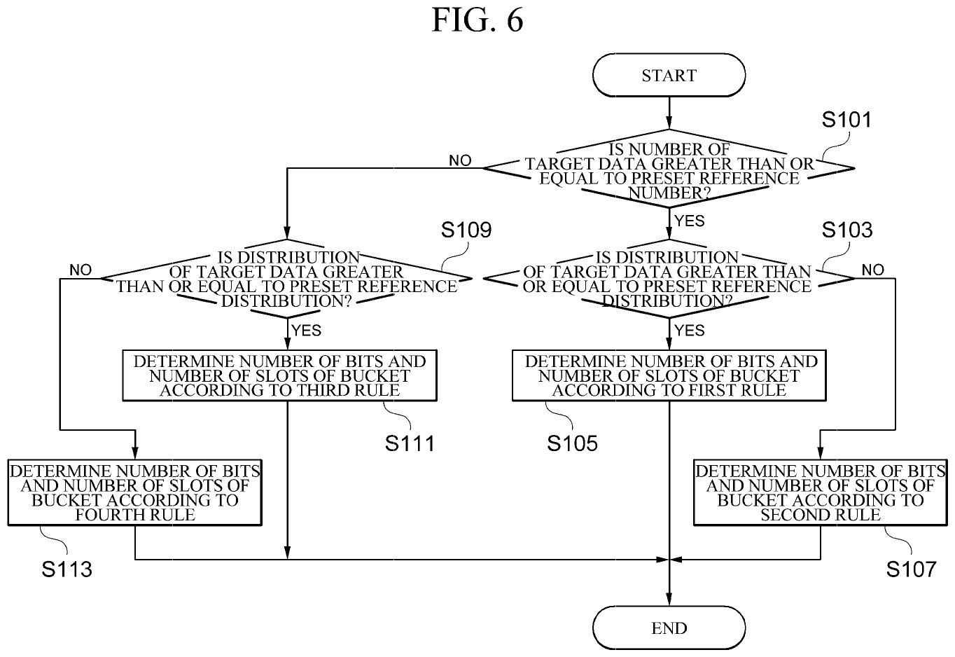

FIG. 6 is a flowchart illustrating a method of determining the number of bits of a bucket and the number of slots of the bucket according to one embodiment of the present invention. As described above, the determination method according to one embodiment of the present invention may be performed by the computing device 12 including one or more processors and a memory in which one or more programs to be executed by the one or more processors are stored. To this end, the determination method may be configured in the form of a program or a software including one or more computer-executable instructions and be stored in the memory.

In the illustrated flowchart, the method is described as being divided into a plurality is of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed. Additionally, the method is merely an embodiment for determining the number of bits of a bucket and the number of slots of a bucket and the present invention is not limited thereto and may include various methods.

Referring to FIG. 6, the computing device 12 checks whether the number of target data is greater than or equal to a preset reference number (S101).

When a result of checking in operation S101 shows that the number of target data is greater than or equal to the preset reference number, the computing device 12 checks whether the distribution of target data is greater than or equal to a preset reference distribution (S103).

Here, the distribution of the target data may be obtained through variance and standard deviation of the target data. In this case, variance and standard deviation may be obtained using all the target data, but the present invention is not limited thereto and the variance and the standard deviation may be obtained using only some of the target data. For example, when the number of target data is N, some (e.g., 10%) of the N target data may be used to obtain variance and standard deviation. In addition, the distribution of the target data may be obtained through the minimum and maximum values of the target data.

When a result of checking in operation S103 shows that the distribution of the target data is greater than or equal to the preset reference distribution, the computing device 12 determines the number of bits of a bucket and the number of slots of the bucket according to a preset first rule (S105).

Here, the preset first rule may be to set the number of bits of the first-level bucket to be greater than the preset reference number of bits and to set the number of slots of the first-level bucket to be smaller than the preset reference number of slots. In addition, in the case of a bucket of a lower level than the first level, the number of bits may be set to be smaller than the preset reference number of bits and the number of slots may be set to be greater than the preset reference number of slots.

That is, when the number of target data is greater than or equal to the preset reference number and the distribution of the target data is greater than or equal to the preset reference distribution, it indicates that a large amount of data is widely distributed, and hence, by determining the number of bits of a bucket and the number of slots of the bucket according to the first rule, the target data may be allowed to be mostly classified to a bucket of the second level or a lower level, rather than being classified to a bucket of the first level.

When a result of checking in operation S103 shows that the distribution of the target data is smaller than the preset reference distribution, the computing device 12 determines the number of bits of a bucket and the number of slots of the bucket according to a preset second rule (S107).

Here, the preset second rule may be to set the number of bits of a first-level bucket to be greater than the preset reference number of bits and to set the number of slots of a first-level bucket to be greater than the preset reference number of slots. In addition, in the case of a bucket of a lower level than the first level, the number of bits may be set to be smaller than the preset reference number of bits and the number of slots may be set to be smaller than the preset reference number of slots.

That is, if the number of target data is greater than or equal to the preset reference number and the distribution of target data is smaller than the preset reference distribution, it indicates that a large amount of data are mainly distributed over a specific range. Hence, by determining the number of bits of a bucket and the number of slots of the bucket according to the second rule, data not falling within the specific range may be classified to a first-level bucket, thereby preventing an additional bucket of a lower level from being generated for the data not falling within the specific range. Also, data falling within the specific range may be classified in a bucket of the second level or a lower level.

When a result of checking in operation S101 shows that the number of target data is less than the preset reference number, the computing device 12 checks whether the distribution degree of the target data is greater than or equal to the preset reference distribution (S109).

When a result of checking in operation S109 shows that the distribution of the target data is greater than or equal to the preset reference distribution, the computing device 12 determines the number of bits of a bucket and the number of slots of the bucket according to a preset third rule (S111).

Here, the preset third rule may be to set the number of bits of the first-level bucket to be smaller than the preset reference number of bits and to set the number of slots of the first-level bucket to be greater than the preset reference number of slots. Also, in the case of a bucket of a lower level than the first level, the number of bits may be set to be greater than the preset reference number of bits and the number of slots may be set to be smaller than the preset reference number of slots.

That is, when the number of target data is less than the preset reference number and the distribution of the target data is greater than or equal to the preset reference distribution, it indicates that a small amount of data is widely distributed. Hence, by determining the number of bits of a bucket and the number of slots of the bucket according to the third rule, it may be possible to classify the target data in the first-level bucket as much as possible and to prevent an additional lower-level bucket from being generated.

When a result of checking in operation S109 shows that the distribution of the target data is smaller than the preset reference distribution, the computing device 12 determines the number of bits of a bucket and the number of slots of the bucket according to a preset fourth rule (S113).

Here, the preset fourth rule may be to set the number of bits of the first-level bucket to be less than the preset reference number of bits and to set the number of slots of the first-level bucket to be less than the preset reference number of slots. Also, in the case of a bucket of a lower level than the first level, the number of bits may be set to be greater than the preset reference number of bits and the number of slots may be set to be greater than the preset reference number of slots.

That is, when the number of target data is less than the preset reference number and the distribution of target data is smaller than the preset reference distribution, it indicates that a small amount of data is mainly distributed in a specific range. Hence, by determining the number of bits of a bucket and the number of slots of the bucket according to the fourth rule, data distributed in a wide range other than the specific range may be allowed to be classified to an additional lower-level bucket, rather than being classified to a first-level bucket.

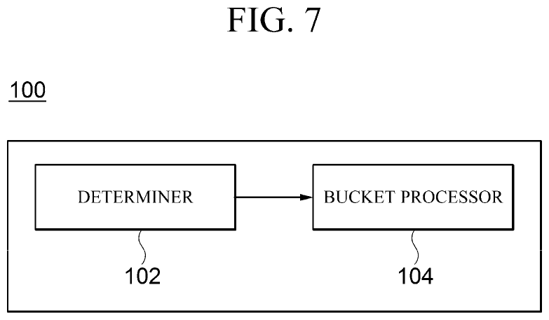

FIG. 7 is a block diagram illustrating a configuration of an apparatus for data alignment according to one embodiment of the present invention.

Referring to FIG. 7, the apparatus 100 for data alignment may include a determiner 102 and a bucket processor 104.

The determiner 102 may count the number of input target data and calculate a distribution of the input target data. The determiner 102 may determine the number of bits of a bucket and the number of slots of the bucket for aligning the target data according to the number of input target data and the distribution of the target data.

The bucket processor 104 may generate buckets of each level according to the determination made by the determiner 102 and allocate the target data to a corresponding bucket to align the target data. Specifically, the bucket processor 104 may generate a first-level bucket having a number of bits and a number of slots as determined by the determiner 102, and allocate and store some of the target data to the bucket.

When the first-level bucket is completely filled with the target data, the bucket processor 104 may generate buckets of lower levels (e.g., a second level and a third level) as determined by the determiner 012, and may allocate and store the remaining target data to a corresponding bucket.

According to the disclosed embodiment, buckets are dynamically are generated according to the number of target data and a distribution of the target data, and thereby performance of alignment of the target data can be improved.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of data alignment which is performed by a computing device comprising one or more processors and a memory in which one or more programs to be executed by the one or more processors are stored, the method comprising:
counting the number of target data to be aligned;
calculating a distribution of the target data;
determining the number of bits of a bucket and the number of slots of the bucket for aligning the target data on the basis of the number of target data and the distribution of the target data; and
generating buckets corresponding to the determined numbers of bits and slots and allocating the target data to the buckets to align the target data.

2. The method of claim 1, wherein the determining comprises checking whether the number of target data is greater than or equal to a preset reference number, checking whether the distribution of the target data is greater than or equal to a preset reference distribution when the number of target data is greater than or equal to the preset reference number, and determining the number of bits of a bucket and the number of slots of a bucket according to a preset first rule when the distribution of the target data is greater than or equal to the preset reference distribution.

3. The method of claim 2, wherein the determining of the number of bits of the bucket and the number of slots of the bucket according to the first rule comprises setting the number of bits of a bucket of a first level to be greater than the preset reference number of bits and setting the number of slots of the bucket of the first level to be smaller than the preset reference number of slots.

4. The method of claim 3, wherein the determining of the number of bits of the bucket and the number of slots of the bucket according to the first rule comprises, in a case of a bucket of a lower level than the first level, setting the number of bits of the bucket of the lower level to be less than the preset reference number of bits and setting the number of slots of the bucket of the lower level to be greater than the preset reference number of slots. 5. The method of claim 2, further comprising, when the distribution of the target data is less than the preset reference distribution, determining the number of bits of a bucket and the number of slots of a bucket according to a preset second rule; and
the determining of the number of bits of the bucket and the number of slots of the bucket according to the second rule comprises setting the number of bits of a bucket of a first level to be greater than the preset reference number of bits and setting the number of slots of the bucket of the first level to be greater than the preset reference number of slots.

6. The method of claim 5, wherein the determining of the number of bits of the bucket and the number of slots of the bucket according to the second rule comprises, in a case of a bucket of a lower level than the first level, setting the number of bits of the bucket of the lower level to be less than the preset reference number of bits and setting the number of slots of the bucket of the lower level to be less than the preset reference number of slots.

7. The method of claim 1, wherein the determining comprises checking whether the number of target data is greater than or equal to a preset reference number, checking whether the distribution of the target data is greater than or equal to a preset reference distribution when the number of target data is less than the preset reference number, and determining the number of bits of a bucket and the number of slots of a bucket according to a preset third rule when the distribution of the target data is greater than or equal to the preset reference distribution.

8. The method of claim 7, wherein the determining of the number of bits of the bucket and the number of slots of the bucket according to the third rule comprises setting the number of bits of a bucket of a first level to be less than the preset reference number of bits and setting the number of slots of the bucket of the first level to be greater than the preset reference number of slots.

9. The method of claim 8, wherein the determining of the number of bits of the bucket and the number of slots of the bucket according to the third rule comprises, in a case of a bucket of a lower level than the first level, setting the number of bits of the bucket of the lower level to be greater than the preset reference number of bits and setting the number of slots of the bucket of the lower level to be less than the preset reference number of slots.

10. The method of claim 7, further comprising, when the distribution of the target data is less than the preset reference distribution, determining the number of bits of a bucket and the number of slots of a bucket according to a preset second rule; and
the determining of the number of bits of the bucket and the number of slots of the bucket according to the fourth rule comprises setting the number of bits of a bucket of a first level to be less than the preset reference number of bits and setting the number of slots of the bucket of the first level to be less than the preset reference number of slots.

11. The method of claim 10, wherein the determining of the number of bits of the bucket and the number of slots of the bucket according to the fourth rule comprises, in a case of a bucket of a lower level than the first level, setting the number of bits of the bucket of the lower level to be greater than the preset reference number of bits and setting the number of slots of the bucket of the lower level to be greater than the preset reference number of slots.

12. The method of claim 1, wherein the generating of the buckets comprises generating buckets of a first level corresponding to the determined numbers of bits and slots and allocating and storing data of a predetermined most significant bit among the target data to the bucket of the first level, and when a slot of a bucket corresponding to a predetermined bit value among the buckets of the first level is occupied, generating buckets of a second level for the corresponding bucket of the first level corresponding to the determined numbers of bits and slots.

13. A computing device comprising:
one or more processors;
a memory; and
one or more programs,
wherein the one or more programs are stored in the memory and configured to be executed by the one or more processors, and the one or more programs comprise instructions for:
counting the number of target data to be aligned;
calculating a distribution of the target data;
determining the number of bits of a bucket and the number of slots of the bucket for aligning the target data on the basis of the number of target data and the distribution of the target data; and
generating buckets corresponding to the determined numbers of bits and slots and allocating the target data to the buckets to align the target data.

14. An apparatus for data alignment comprising:
a determiner configured to count the number of target data to be aligned, calculate a distribution of the target data, and determine the number of bits of a bucket and the number of slots of the bucket for aligning the target data on the basis of the number of target data and the distribution of the target data; and
a bucket processor configured to generate buckets corresponding to the determined numbers of bits and slots and allocate the target data to the buckets to align the target data.

15. A computer program, stored in a non-transitory computer-readable storage medium, comprising one or more instructions which, when executed on a computing device comprising one or more processors, cause the computing device to perform operations comprising:
counting the number of target data to be aligned;
calculating a distribution of the target data;
determining the number of bits of a bucket and the number of slots of the bucket for aligning the target data on the basis of the number of target data and the distribution of the target data; and
generating buckets corresponding to the determined numbers of bits and slots and allocating the target data to the buckets to align the target data.
